(19) United States
(12) Patent Application Publication
(10) Pub. No.: US 2011/0207537 A1
(43) Pub. Date: Aug. 25, 2011

(54) UNIVERSAL JOINT ARRANGEMENT FOR AN ARTICULATED SHAFT

(76) Inventors: Peter Grawenhof, Dettingen (DE); Simon Ritter, Medlingen (DE)

(21) Appl. No.: 12/737,960

(22) PCT Filed: Sep. 25, 2009
(86) PCT No.: PCT/EP2009/006918

§ 371 Date: May 2, 2011

(30) Foreign Application Priority Data
Sep. 29, 2008 (EP) 10 2008 049 348.1

(51) Int. Cl. F16D 3/41; F16D 3/38

(52) U.S. Cl. 464/112

(57) ABSTRACT

The invention relates to a universal joint arrangement for an articulated shaft, particularly a heavy-duty articulated shaft. The universal joint arrangement comprises two joint forks having fork holes, and a journal cross. The journals of the journal cross are each supported through bearing devices in the fork holes. The bearing devices comprise at least one axial bearing and at least one radial bearing for the respective journal. The axial bearing is arranged in the area of the journal shoulder. The fork hole comprises a contact collar on the inside of said fork hole, and the journal shoulder of the respective journal comprises a contact surface. The axial bearing is now arranged between the contact surface and the contact collar. A minimum path between the force application and the support of the axial bearing is thereby realized, which makes possible an extremely robust axial bearing support and which can do without additional attachment rims for supporting axial force. The installation space gained can be used advantageously to increase the radial bearing capacity.

The invention relates to a universal joint arrangement for an articulated shaft, especially a heavy-duty articulated shaft, with the features as designated in closer detail in the preamble of claim 1.

Articulated shafts for the transmission of torques are generally known and used. The joints or also universal joints are typically formed by a journal cross and two forks which are twisted by 90 degrees with respect to one another, with each journal of the journal cross being arranged in a fork hole of the respective shaft of the forks. In order to transmit respectively high torques permanently in a reliable manner with the articulated shafts, especially heavy-duty articulated shafts, the journals in the fork holes are mounted in a respective manner because there is continual pivoting movement of the journals in relation to the fork holes during operation.

Especially in the case of heavy-duty articulated shafts which are especially provided in rolling mills and main drives for rolling steel, very high torques in a magnitude of several thousand kilonewton meters are transmitted. In order to manage this, the journals are typically mounted with radial bearings and axle bearings in the fork holes. Special attention shall especially be given to the axial bearings below.

The usual manner of bearing is that the axial bearing occurs via plain bearing elements or rolling bearing elements which are supported against a securing ring which is introduced from the outside into the fork hole.

An alternative is known from EP 0 785 370 A1 in which the bearing of the journals rests on a bearing collar in the outside region of the respective fork hole. During mounting, the journal cross is threaded accordingly into the fork holes, whereupon the introduction of the bearing arrangement follows from the outside before the fork hole is sealed by means of a respective cover.

As an alternative to this, the fork hole can also be arranged in the form of a pocket hole. Reference is hereby made to DE 299 20 839 U1. In the case of such an arrangement which requires a divided fork, the bearing arrangement is placed accordingly on the journals of the journal cross before they are introduced into the fork hole.

All these arrangements come with two disadvantages however. The support of the axial bearing is provided either on a securing ring, a bearing collar or a bearing cover, or in the case of the pocket hole bore of the fork hole in the cover region integrally arranged with the fork. Since very high forces occur in articulated shafts, especially heavy-duty articulated shafts, relatively high material thicknesses are required for the support of the axle bearing in the region of the fork hole facing away from the rotational axis of the articulated shaft and thus a respectively large amount of space. This is especially also due to the fact that the forks which may not protrude beyond the diameter of the actual articulated shaft are provided in these regions with a round configuration, so that in the region of the “cover” used for the support there is a rather low available material thickness anyway.

The required thickness of the material delimits the region however in which the radial bearings of the respective journal extend. Since a region of the radial bearing which is disposed as far outside as possible would be especially advantageous concerning the leverage, this axial bearing represents a disadvantage in strength for the axial bearing per se and, in connection with this, also a disadvantage for the respective leverage in the radial bearing.

Reference shall be made here to two further specifications on the state of the art, which are DE 10 2005 058 742 A1 and DE 10 2005 058 743 A1. Both specifications describe axial bearing arrangements which as a result of a special configuration are arranged to be supporting only in specific regions, whereas other regions are formed by means of recesses or partially elastic sections. As a result, the axial bearing is arranged to be supporting only in the regions in which comparatively low relative movements occur between journal and fork hole during operation in the case of a respective installation position, so that the strain on the axial bearings is reduced considerably and the service life of the articulated shaft can be extended.

It is the object of the invention to reduce the disadvantages as mentioned above concerning the axial bearing and to provide a universal joint arrangement which ensures the longest possible service life in combination with minimum required space, especially also for heavy-duty articulated shafts.

This object is achieved in accordance with the invention by the features as mentioned in the characterizing part of claim 1.

The arrangement in accordance with the invention not only displaces the axial bearing, but also its support on the articulated shaft borehole to the inside, i.e. the side of the fork hole which faces the rotational axis of the articulated shaft. A minimum path between the force application and the support of the axle bearing is thereby realized, thus enabling an extremely robust axle bearing support and thus allowing the omission of additional attachment rims for the supporting axial force. The installation space gained can be used advantageously to increase the radial bearing capacity.

In accordance with the invention, a minimum distance occurs between the support of the axle bearing and the force application on the fork. As a result, the force is transferred via an exceptionally short path directly from the journal cross into the fork. The regions of the fork hole and the journal which are disposed on the outside from the direction of the rotational axis of the articulated shaft are thus not subjected to any direct forces in the axial direction of the journal. Accordingly, the bearing elements of the radial bearing can be displaced or expanded maximally far to the outside. A considerably larger leverage for the radial bearing can thus be utilized in comparison with the state of the art.

Since the transmission of the torque occurs primarily via the radial bearings of the journals in the fork holes in articulated shafts, this configuration is especially advantageous because larger torques can be transmitted by the maximum leverage at the same diameter or a longer service life can be realized than in the embodiments according to the state of the art.

Further advantageous embodiments of the universal joint arrangement are provided by the dependent claims and the embodiments which will be explained below in closer detail by reference to the drawings, wherein:

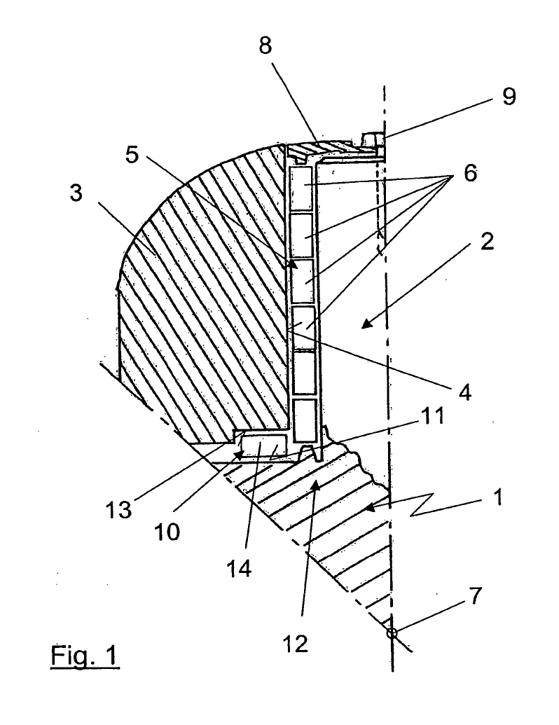

FIG. 1 shows the first embodiment of a journal bearing in the universal joint arrangement in accordance with the invention;

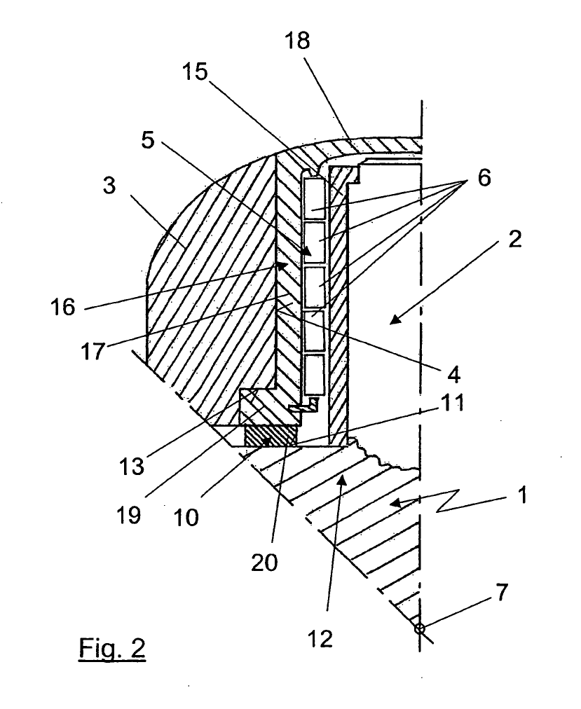

FIG. 2 shows a second embodiment of a journal bearing in the universal joint arrangement in accordance with the invention;

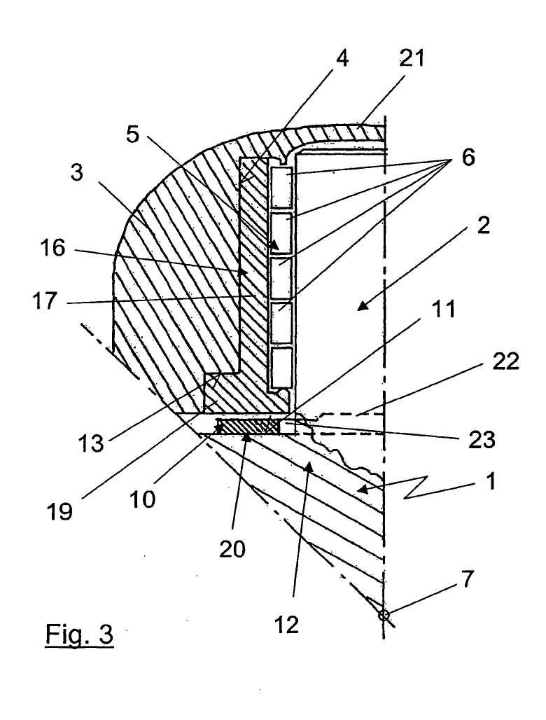

FIG. 3 shows a third embodiment of a journal bearing in the universal joint arrangement in accordance with the invention.

FIG. 1 shows a sectional view of a universal joint arrangement in which a portion of a journal cross 1 can be seen. A journal 2 of the journal cross 1 is shown in a fork 3 and a fork hole 4 in fork 3. The journal 2 is held via a radial bearing 5 in the fork hole 4, with the radial bearing 5 being formed here by the inside surface of the bearing hole 4 and the outside surface of journal 2 with interposed rolling elements 6. The radial bearing 5 with the rolling elements 6 is indicated only in principle, so that a merely exemplary illustration of the rolling elements 6 was chosen. Typically, cylindrical rolling elements are especially suitable in this case because high forces or torques need to be transmitted by the universal joint arrangement. In order to simplify the illustration, only some of the rolling elements 6 of the radial bearing 5 have been provided with reference numerals.

The fork hole 4 is sealed by means of a cover 8 on the side facing away from the rotational axis 7 of the articulated shaft. Said cover 8 is connected by way of example by a fastening means 9, which in this case is a screw, with the journal 2. It could also be connected directly with the fork 3 itself however. An axial bearing 10 is also necessary in addition to the radial bearing 5 for the journal 2 in the fork 3 which transmits the highest forces or torques of the universal joint arrangement, this being in order to absorb axial forces between the fork 3 and the journal cross 1 or the respective journal 2.

The special aspect in this configuration is that said axial bearing 10 is arranged between a contact surface 11 in the region of a journal shoulder 12 of the respective journal 2 and a contact collar 13 in the region of the fork 3 or in the region of the fork hole 4 associated with the rotational axis 7 of the articulated shaft. If a pure axial bearing is concerned, the contact surface 11 and the surface of the contact collar 13 which corresponds with the bearing should each be arranged perpendicularly to the axis of the respective journal 2. If a radial share of forces is also to be transmitted, a respective angle of the surfaces can also be provided.

The axial bearing 10, which is indicated in FIG. 1 by a rolling element 14 as a rolling bearing by way of example, comes with the advantage in comparison with the state of the art that between the contact surface of the journal 2 and the journal shoulder 12 there is only minimal space under the application of force via the contact collar 13 into the fork 3. The application of the axial forces thus occurs very efficiently on the inside of the fork 3. A maximum supporting surface is available as a result of the circumferential geometry, thus leading to minimal surface pressings. The outside of the fork hole 4 in fork 3 is thus free from direct axial force transmission, so that this region can be used far to the outside for the radial bearing 5. This large expansion of the radial bearing 5 up to a region of the diameter of the articulated shaft which is disposed far to the outside allows maximum leverage for transmitting the forces and torques by the journals 2 onto the fork 3 and vice-versa. As a result, higher forces or torques can be transmitted or a respectively longer service life of the universal joint arrangement with the arrangement of the axial bearing 10 in accordance with the invention can be achieved when similarly high torques or forces are transmitted.

It is principally possible to merely displace the radial bearing 5 to the outside, or it is alternatively possible to extend the radial bearing 5 in the radial direction of journal 2 accordingly as is shown here, and thus to increase the bearing surface accordingly.

In the embodiment as shown in FIG. 1, the bearings 5, 10 are only indicated in a principal and schematic way. The bearings 5, 10 can be arranged as rolling bearings, as shown here. Both bearings 5, 10 could also be arranged as plain bearings. The bearings 5, 10 in FIG. 1 are directly arranged on the respective surfaces of the fork hole 4 or journal 2 or contact surface 11, so that therefore no bearing shells are shown. An inside and/or outside ring of the bearing would principally also be possible.

FIG. 2 shows a comparable arrangement of the respective section of the universal joint arrangement again. In contrast to the illustration in FIG. 1, the radial bearing 5 comprises an inner bearing shell 15 and an outer bearing shell 16. The outer bearing shell 16 is arranged between the rolling elements 6 of the radial bearing 5 and the fork hole 4. The outer bearing shell 16 has several areas. The area which is most important for the function is the actual bearing area 17, on which the rolling elements 6 run accordingly. Moreover, said bearing area 17 converges integrally into a cover element 18 at the end of the bearing hole 4 which faces away from the rotational axis 7 of the articulated shaft. In addition, the outer bearing shell 16 has an axial bearing area 19 which is arranged in the region of the fork between the actual axial bearing 10 and the contact collar 13. Said axial bearing area 19 of the outer bearing shell 16 thus forms a bearing shell for the axial bearing 10.

In the embodiment as shown here, the axial bearing 10 is arranged as a plain bearing, which is respectively indicated here by an exemplary plain bearing ring 20. A plain bearing for the axial bearing 10 is certainly sufficient and also widely used in respective universal joint arrangements due to the fact that the highly loaded radial bearing 5 is used for the primary transmission of forces and torques and the axial bearing 10 plays a subordinate role in comparison with this. A simple and efficient configuration with a low overall size of the bearing can be achieved with such a plain bearing, e.g. made of a plain bearing ring 20 of a suitable material (bronze for bearings, plastic or the like).

The distance between the contact surface 11 and the contact collar 13 is also comparatively small in the embodiment in FIG. 2. In this case too, the axial bearing is arranged in the region of the bearing hole 4 facing the rotational axis 7 of the articulated shaft, so that the opposite outer area of the bearing hole 4 is available for the radial bearing 5 far out to the outside in order to enable the advantages as mentioned above.

The arrangement of the outer bearing shell in the illustration according to FIG. 2 requires a respective installation of the journal 2 in the bearing hole 4 from the side facing the rotational axis 7 of the articulated shaft. In order to enable the realization of this, the fork 3 needs to be arranged in a divided manner. Several alternatives are principally possible which are already known in this way in the state of the art. Either the fork hole 4 can be divided itself, as is conventionally the case in a connecting rod for example. It is also possible alternatively that the bearing hole 4 is introduced into respective pillow blocks which can then be screwed together with a driving flange of the fork. The pillow blocks can then be placed accordingly on the journals 2 in order to then be screwed together with the flange of the fork driver. The third possible embodiment is to divide the fork or the flange of the fork itself. The divided flange allows moving the two ends and thus the two fork holes in the axial direction of the two journals 2 which correspond with the same, so that the forks 3 can be placed on the journals and can then be fixed accordingly.

During the mounting of the embodiment according to FIG. 2, the outer bearing ring 16, which forms a kind of a bushing together with the cover element 18, is slid or pressed into the fork hole 4. The axial bearing area 19 of the outer bearing shell 16 thus comes to lie on the contact collar 13. A respective mounting of the bearing elements, especially the rolling elements 6 and the sliding ring 20 and journal 2, can then occur.

The inner bearing shell 15 needs to be placed on the journal 2 beforehand. The inner bearing shell 15 ensures that also the inner bearing of the rolling elements 6 on a respective bearing shell 15 is made. Since the convex rolling elements run on the convex surface of the journal 2 or the convex surface of the bearing shell 15 in the region of said inner bearing shell 15, surface pressing and thus the stress on the radial bearing 5 is especially high in this region. This can lead to increased wear and tear especially in the region of the inner bearing shell 15. The configuration according to FIG. 2 allows exchanging this inner bearing shell 15 in a comparatively simple way, so that a simple and relatively cost-effective reconstruction is possible if the radial bearing 5 should be worn off at this location.

If, as is shown in FIG. 1, such an inner bearing shell is omitted, which would principally also be possible in the configuration according to FIG. 2, the journal 2 itself would wear off and would have to be replaced in its entirety, if necessary. Typically, however, the exchange of the inner bearing shell 15 will be a more cost-effective alternative depending on the size of the articulated shaft.

FIG. 3 shows a third embodiment of the respective section of the universal joint arrangement according to the invention. The fork hole 4 in fork 3 is arranged in this case as a pocket hole, so that a cover element 21 is formed in this case as a part of the fork 3 itself. A configuration is necessary in this case too for mounting purposes in which the fork 3 can be divided accordingly, comparable with the bushing-like outer bearing shell as in the embodiment according to FIG. 2. The configuration corresponds in all other respects to the description as made above. It also shows an outer bearing shell 16 of the radial bearing 5. The inner bearing shell 15 was omitted in the embodiment according to FIG. 3. The outer bearing shell 16 comprises the actual bearing area 17 and the axial bearing area 19. Since the cover element 21 is arranged integrally with the fork in this case, the outer bearing shell 16 is arranged in a substantially annular manner, so that accordingly no cover element 18 belongs to the outer bearing shell 16.

The second special feature as compared with the preceding drawings can be found in this case in the region of the plain bearing ring 20 of the axial bearing 10. Said plain bearing ring 20 comprises supporting regions 22 and accordingly non-supporting regions 23. This embodiment for the plain bearing ring 20 is principally known from the state of the art. Reference in this respect is made to the initially mentioned German applications DE 10 2005 058 742 and DE 10 2005 058 743 of the applicant.

A relative movement of the journal 2 in relation to the fork hole 4 occurs as a result of the mechanical loading of the universal joint arrangement. As is explained in closer detail in the above specifications, this relative movement has regions in which a comparatively large relative movement occurs in the components with respect to one another, and other regions in which there is rather small relative movement of the components with respect to each other. The plain bearing ring 20 of FIG. 3 is arranged in such a way that it comprises supporting regions 22 and non-supporting regions 23. The supporting regions 22 are arranged symmetrically and in a locally limited manner on the plain bearing ring 20. The same does not apply to the non-supporting regions 23. This configuration ensures that the axial bearing occurs primarily in the region of the supporting regions 22. The deforming journal can perform a comparatively large relative movement in relation to the fork 3 and the fork hole 4 in the non-supporting regions 23 before it touches the plain bearing ring 20 in the region of the non-supporting regions 23 and is carried accordingly.

A conventional plain bearing ring 20 of comparable thickness over its entire diameter would wear off relatively quickly in regions in which relatively large relative movements occur with respect to one another. The plain bearing ring 20 as illustrated here is not loaded or only minimally loaded in the non-supporting regions 23, whereas in the supporting regions there is comparatively even loading. As a result, the plain bearing ring 20 will not wear off so quickly in its entirety, which contributes advantageously to the service life and length of the maintenance intervals of the universal joint arrangement.

As an alternative to the omission of material in the region of the non-supporting regions 23, a respective elastic material could be introduced into these non-supporting regions 23. It would further be possible that the subdivision into support and non-supporting regions is not realized by the geometric configuration of the plain bearing ring 20, but by a respective configuration in the further areas involved in the bearing. The contact surface 11 could be arranged in such a way for example that it is provided with a planar arrangement in the area of the supporting regions and is provided with depressions in the region of the non-supporting regions. The same obviously also applies to the axial bearing area 19 of the outer bearing shell 16 or the surface of the contact collar 13. It is possible in each case to realize this subdivision of the axial bearing 10 into supporting regions 22 and non-supporting regions 23 by respective recesses or areas filled with an elastic material or elastic spring means or the like. The plain bearing ring 20 is then able to “yield” into these depressions or recesses in the regions with larger relative movement of the fork hole 4 relative to the journal 2 and thus “avoid” high loads and high wear and tear.

The described individual measures can be provided on one of the mentioned components, or combinations of recesses and/or elastic means in several of the mentioned components that are involved in the axial bearing 10.

The variants of the invention illustrated in closer detail by means of the three drawings have the short path between the contact of the axial bearing 10 and the application of force into the fork 3 in common. This is achieved in various ways with or without a bearing shell, with rolling bearings 14 for the axial bearing 10 or a plain bearing 20 for the axial bearing 10. These variants can easily be combined by the person skilled in the art. The same also applies to the configuration of the bearing hole or cover element 18, 21. The inner bearing ring 15 could be used in all three variants for example. It would also be possible that the outer bearing shell 16 is realized without the inner bearing shell in a bush-like configuration according to FIG. 2, or that it is combined accordingly with the plain bearing ring 20 of FIG. 3 or also the rolling bearing elements of FIG. 1. The structure and configuration of the outer bearing shell 16 could obviously also be realized without a respective axial bearing region 19 and could thus be integrated accordingly into the configuration according to FIG. 1. It is also possible for all variants to use either a pocket-hole bore as a fork hole 4 or the use of a separate cover 8, as also the integral arrangement of the cover with the outer bearing shell 16.

Depending on the configuration, the bearing of the pin 2 in the fork hole 4 can also comprise one or several sealing means. Such sealing means are principally known from the state of the art for universal joint arrangements, so that they are not shown in closer detail in the drawings. Respective seals must be provided in the region of the fork hole 4 and/or especially in the region of the journal shoulder 12 depending on the arrangement of the fork hole 4 as a pocket-hole bore or with cover 8 or a cover element 18 which is integrally arranged with the outer bearing shell 16. Such sealing measures are obvious and well known to a person skilled in the art, so that this will not be discussed here in closer detail and an illustration in FIGS. 1 to 3 was not provided.

1-16. (canceled)

17. A universal joint arrangement for an articulated shaft, especially a heavy-duty articulated shaft, comprising:
a journal cross;
two joint forks having fork holes for accommodating one respective journal of the journal cross;
one respective bearing apparatus of the journal in the fork hole, with
the bearing apparatus comprising at least one axial bearing and at least one radial bearing for the journal, and with
the axial bearing being arranged in the region of the journal shoulder,
characterized in that
the fork hole comprises a contact collar on its side facing a rotational axis of the articulated shaft;
the journal shoulder has a contact surface, and
the axial bearing is arranged between contact surface and contact collar.

18. The universal joint arrangement according to claim 17, characterized in that the radial bearing is made of rolling elements and an outer bearing shell arranged between the rolling elements and the fork hole.

19. The universal joint arrangement according to claim 17, characterized in that the radial bearing comprises an inner bearing shell between the rolling elements and the journal.

20. The universal joint arrangement according to claim 18, characterized in that the radial bearing comprises an inner bearing shell between the rolling elements and the journal.

21. The universal joint arrangement according to claim 17, characterized in that the surface of the contact collar supporting the axial bearing is arranged perpendicularly in relation to the axis of the respective journal.

22. The universal joint arrangement according to claim 18, characterized in that the surface of the contact collar supporting the axial bearing is arranged perpendicularly in relation to the axis of the respective journal.

23. The universal joint arrangement according to claim 19, characterized in that the surface of the contact collar supporting the axial bearing is arranged perpendicularly in relation to the axis of the respective journal.

24. The universal joint arrangement according to claim 20, characterized in that the surface of the contact collar supporting the axial bearing is arranged perpendicularly in relation to the axis of the respective journal.

25. The universal joint arrangement according to claim 17, characterized in that the contact surface is arranged perpendicularly in relation to the respective journal in the region of the journal shoulder.

26. The universal joint arrangement according to claim 17, characterized in that the axial bearing is arranged as a plain bearing ring.

27. The universal joint arrangement according to claim 17, characterized in that the axial bearing is formed by rolling elements arranged between the contact collar and the contact surface.

28. The universal joint arrangement according to claim 17, characterized in that the axial bearing comprises at least one bearing shell.

29. The universal joint arrangement according to claim 28, characterized in that the at least one bearing shell of the axial bearing is arranged as a part of the outer bearing shell of the radial bearing, with the bearing shell resting on the contact collar.

30. The universal joint arrangement according to claim 17, characterized in that the fork hole is sealed with a cover on its side facing away from the rotational axis of the articulated shaft.

31. The universal joint arrangement according to claim 30, characterized in that the cover and the outer bearing shell of the radial bearing are arranged integrally.

32. The universal joint arrangement according to claim 17, characterized in that the fork hole is arranged as a pocket hole from the side facing the rotational axis of the articulated shaft.

33. The universal joint arrangement according to claim 17, characterized in that the axial bearing is arranged in such a way that it comprises locally limited and oppositely disposed supporting regions in the region of the plain bearing ring and/or the at least one bearing shell and/or the contact surface and/or the contact collar.

34. The universal joint arrangement according to claim 33, characterized in that the supporting regions are arranged in the installed position of the axial bearing in the region of low relative movements between the journal and the fork holes.

35. The universal joint arrangement according to claim 33, characterized in that the axial bearing comprises recesses and/or elastic means in the regions in which it does not have any supporting regions, in the region of the plain bearing ring and/or the at least one bearing shell and/or the contact surface and/or the contact collar.

36. The universal joint arrangement according to claim 17, characterized in that sealing means are provided for sealing the bearings, at least the radial bearing.
